(19) United States
(12) Patent Application Publication
(10) Pub. No.: US 2022/0066077 A1
(43) Pub. Date: Mar. 3, 2022

(54) Multilayer Light Ray Moderator with Three-Dimensional Angular Selectivity of Transmittance of Directional Light

(71) Applicant: Christopher Dustin Hague, Las Vegas, NV (US)

(72) Inventor: Christopher Dustin Hague, Las Vegas, NV (US)

(21) Appl. No.: 17/008,637

(22) Filed: Sep. 1, 2020

(51) Int. Cl. G02B 5/26; G02B 5/20

(52) U.S. Cl. CPC G02B 5/26; G02B 5/201

(57) ABSTRACT

A variable transmission moderator having an aggregated plurality of structured planes fixed in spatial adjacency, said planes are subdivided into modules consisting of irregular collection of light-reduction geometries for selectively filtering of three-dimensional angles of directional light transmission.

### REFERENCE

This application claims the benefit of provisional patent application Ser. No. 68/868,910, filed Jun. 29, 2019 by the present inventor(s), which is incorporated by reference in its entirety.

### TECHNICAL FIELD

The present invention relates to variable light transmission through a moderator, and specifically, relates to angular selectivity of directional light transmission through the moderator as a function of three-dimensional angle of incidence on the moderator.

### BACKGROUND

The following tabulation of some prior art that presently appears relevant:

### U.S. Patents

| Patent Number | Kind Code | Issue Date | Patentee |
|---|---|---|---|
| US 2003/0159364 | A1 | Aug. 28, 2003 | Piano et al. |
| US 2014/0185133 | A1 | Jul. 3, 2014 | Shalit |

Light transmission through transparent materials or the lack of transmission through opaque materials may produce unwanted side effects.

For example, near complete transmission of light through a substrate may be deemed excessive when uncomfortably bright to a user or environment where less light is needed.

On the other hand, total light blockage may be deemed restrictive when strainingly dim to a user or reduce usability of an environment moderated by the blockage.

It is known that the prior art of this field is generally populated with three types of technologies: planar transmittance reduction technologies, spatial louver-type technologies, and spatially extruded technologies.

Common frit consists of a planar glass substrate with a repetitively patterned dimensionless opaque material applied to reduce the total amount of light transmittance; striped or dotted frit is a common planar transmittance reduction technology. Also, including transmittance reducing substrates such as tinted glass, and electrochromic devices that use electricity to modify optical properties. Planar devices offer no angular selectivity for transmittance of directional light.

Common louvers are a parallel set of angled slats or flat strips fixed or hung at regular intervals adjacent to a window, or fenestration. Also, including multilayered devices that utilize spatially separated parallel linear opaque applications to control light, since the linear applications as an aggregation function sufficiently similar to louvers. Louvers are aesthetically and structurally imposing to the structures they are affixed to, which can incur additional economic costs. Louvers, or parallel linear devices, as an aggregation can only offer angular selectivity for transmittance of directional light in a plane perpendicular to the long-axis of the slats.

Spatial extrusion devices are typically tubes, or extrusions, such as egg-crate devices, fixed or hung at regular intervals adjacent to a window, or fenestration. Extrusion devices can limit the directional sources to a region in three-dimensional space, but have low resolution of angular selectivity for transmittance of directional light.

Therefore, an economic, non-electric, system for higher resolution of angular selectivity of the transmittance of directional light is needed.

### SUMMARY

In accordance with one embodiment a light moderator consists of multiple layers of parallel planar light attenuation surfaces wherein each surface consists of a plane of an irregular collections of attenuating regions of particular geometries, and the multiple layers are sufficiently separated to leverage the relative geometries of the opaque attenuating regions to selectively moderate the transmission of three-dimensional directional light through the aggregation into the space beyond.

### Advantages

Accordingly several advantages of one or more aspects are as follow: allows a higher resolution moderation of impinging three-dimensional directional light rays, allows a more effective passive heating and cooling of a space with a low-cost construction method such as printed window fit, can be installed during primary construction or as an ad hok improvement, is low maintenance, has no moving parts to break or replace, and is readily fabricated using existing fabrication processes, can be designed to perform in a wide range of climates, orientations, azimuths, and elevations. Other advantages of one or more aspects will be apparent from a consideration of the drawings and ensuing description.

### BRIEF DESCRIPTION OF DRAWINGS

The subject matter disclosed may be best understood by reference to the following detailed description when read with accompanying drawings in which:

FIG. 1 is an exploded axonometric view depicting a given portion of the planar aggregated assembly of parallel light transmissive planes containing patterned modules of an irregular collection of attenuating and non-attenuating regions for a variable light transmission moderator, according to an embodiment of the invention;

FIG. 1A is an axonometric view depicting a given portion of the planar aggregated assembly of parallel light transmissive planes containing patterned modules of an irregular collection of attenuating and non-attenuating regions for a variable light transmission moderator denoting the location and direction of section view FIG. 3, according to an embodiment of the invention;

FIG. 2 is a partial axonometric view depicting light ray interaction with a single module set in two parallel and adjacent light transmissive planes containing patterned modules of an irregular collection of attenuating and non-attenuating regions for a variable light transmission moderator, according to an embodiment of the invention;

FIG. 3 is a section view through a given portion of the planar aggregated assembly of parallel light transmissive planes containing patterned modules of an irregular collection of attenuating and non-attenuating regions for a variable light transmission moderator, according to an embodiment of the invention.

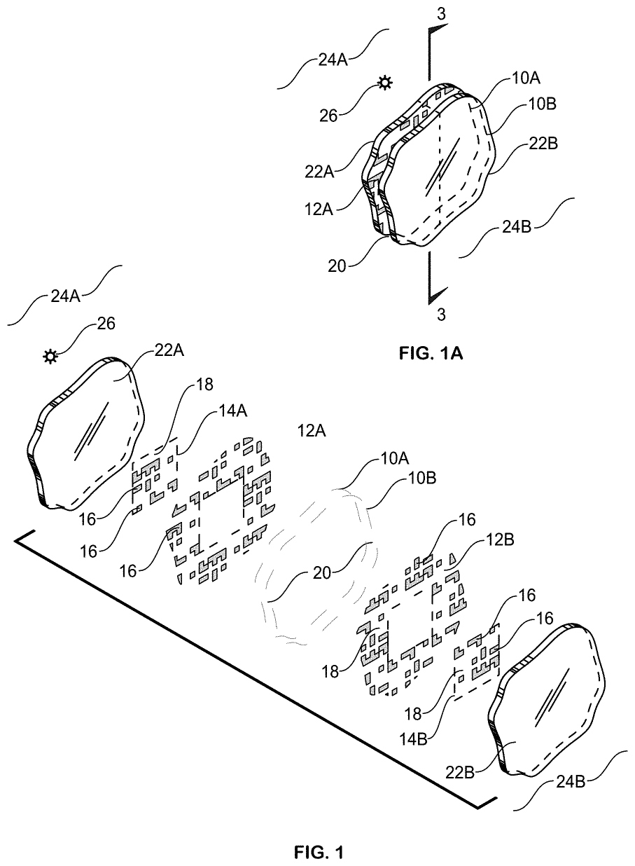

### DETAILED DESCRIPTION OF EMBODIMENTS OF THE INVENTION

The present invention relates to a variable light transmission moderator in which a plurality of parallel structured planes, populated by an multitude of tessellated modules containing an irregular collection of attenuating and non-attenuating regions, separated by an inter-surface gap that sufficiently separated to leverage the relative geometries of the light attenuating regions to selectively moderate the transmission of three-dimensional directional light through the aggregation into the space beyond. Additional factors affecting transmission will be discussed later in this document.

### Terminology

The following terminology will be used throughout the document.

The term “attenuating region” denotes a planar region of optically dismissive properties, that is to say that it reduces the light intensity or transmission.

Conversely, the term “non-attenuating region” or “transparent” denotes a planar region of more optically transmissive properties than adjacent attenuating regions. As a matter of convention, non-attenuating regions are deemed to be non-attenuating with respect to the wavelength attenuated in the attenuated region even if non-attenuating regions are also attenuating for wavelengths different than those of attenuating regions.

The terms “substrate” or “layer” refers to a planar surface of light-transmissive material in which patterned modules of irregular collections of attenuating regions can be applied, or an attenuating sheet of sufficient stiffness perforated with patterned modules of irregular collections of non-attenuating regions.

The term “moderator” refers to the entire agency or system providing the variable light transmission as a function of three-dimensional angle of incidence on the moderator, the agency is formed from at least two light transmissive planar substrates and associated patterned modules of irregular collections of attenuating and non-attenuating regions, inter-surface gaps, and any materials filling the gaps, according to embodiments of this invention.

The term “inter-surface gap” refers to the distance between or spatial adjacency of adjacent patterned layers, the inter-surface gap contains a gas or liquid, or a light transmissive solid medium, or a combination of any of the above.

The term “transmissive” or “transmittance” or “transmission” refers to the passage of the light through a substrate, and specifically refers to the fraction of the incident light traversing the variable light transmission moderator.

The term “light” includes all forms of electromagnetic radiation in the wavelength range of ultraviolet, visible light, infrared, and far infrared and includes sunlight emanating directly from the sun and indirect sunlight.

The term “source” refers to the position of the origin of light impinging on the moderator.

The term “exterior” refers to the environment on the side of the moderator in which the source of light is present or as a matter of convention is designed to be present.

The term “interior” refers to the environment on the side of the moderator in which is moderated by the moderator, or as a matter of convention is opposite the moderator from the exterior.

The term “three-dimensional angle” or “three-dimensional directional light” refers to a vector impinging upon the moderator from a source that is necessary to differentiate from another impinging vector by more dimensions than the angle of incidence to the normal of the plane of the moderator, such as the angle of incidence in relation to the normal of the plane of the moderator and the rotational angle about the normal of the plane of the moderator.

It should be noted that any combination of described embodiments or features are included within the scope of present invention.

### Environment

The environment or the setting of the present invention includes two environments separated locally by the moderator, including the exterior 24A and the interior 24B, whereby the source 26 within the exterior produces directional light 28-32 that is selectively filtered by the moderator as a function of three-dimensional angles of incidence.

### Layers

The moderator comprises at least an exterior plane 10A and an interior plane 10B of tessellations 12A and 12B, respectively. Whereby tessellations 12 comprise modules 14 of irregular collections of attenuating 16 and non-attenuating 18 regions.

The irregular collection of attenuating regions 16 within a module 14 may be applied to an adjacent light transmissive substrate 22 unless the regions are sufficiently interconnected and self-structured. In the case of self-structured attenuating regions, the adjacent light transmissive substrate 22 may be omitted.

In some embodiments, the attenuating regions may be applied to a supportive light transmissive substrate 22 of materials including, inter alia, glass, resin, plastic, or film.

In some embodiments, a combination of self-structured and supported layers may be used within the plurality of layers 18.

In some embodiments, substrates are implemented as a mixture of substrate materials as needed to produce a desired transmission as is known to those skilled in the art.

### Attenuating Regions

The moderator comprises a plurality of planar layers of tesselated modules containing an irregular collection of attenuating 16 and non-attenuating 18 regions.

Attenuating regions are non-linear planar shapes and of a thinness appropriate to the material as is known to those skilled in the art. The irregular collection of attenuating regions 16 in a module 14 in tessellation 12 may be fabricated of materials including; inter alia, paint, pigment, ceramics, metal, resin, or plastic.

Furthermore, attenuating 16 and non-attenuating 18 regions shall be sized larger than the largest wavelength of light within the spectrum to limit diffraction of light as it traverses the individual layers and the moderator.

Attenuating regions 16 within the tessellated modules 14 within a specific planar layer 18 within the plurality all contain the same irregular collection, and although in some embodiments the plurality of layers may have different irregular collections within respective modules within respective layers.

Subdivided planes 10 of tessellations 12 are separated by inter-layer gap 20.

### Operation

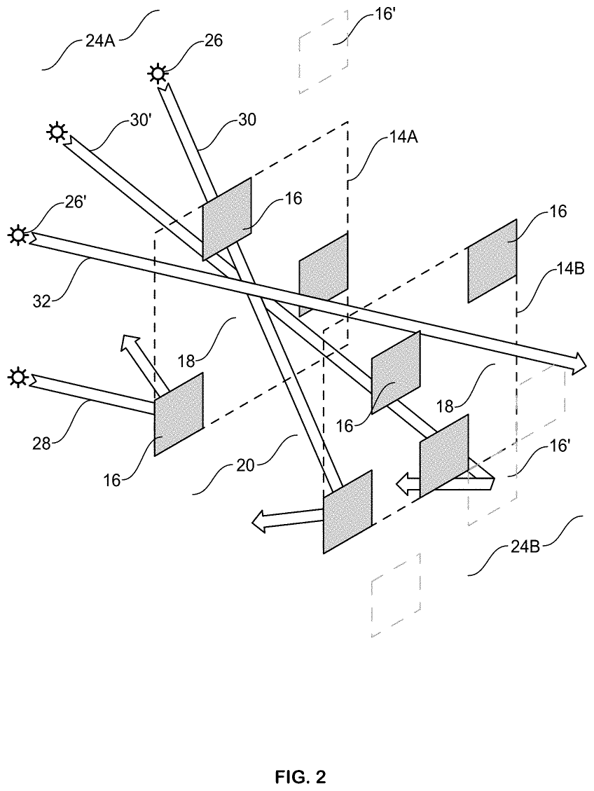

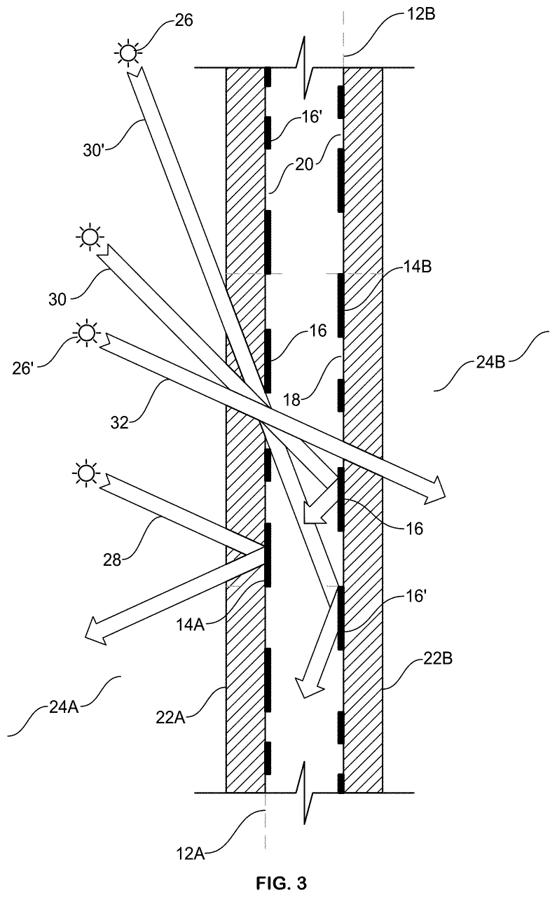

FIG. 2 and FIG. 3 schematically show an example of three-dimensional angular selectivity of transmittance of directional light for a possible impinging light ray 28 from source 26. Impinging light ray 28 is rejected from transmission by an attenuation region 16 in module 14A of tessellation layer 12A.

FIG. 2 and FIG. 3 schematically show an example of three-dimensional angular selectivity of transmittance of directional light for a possible impinging light ray 30 from source 26. Impinging light ray 30 is transmitted through tessellation layer 12A through a non-attenuating region of module 14A and inter-layer gap 20, but is rejected by an attenuation region 16 within module 14B of tessellation layer 12B.

FIG. 2 and FIG. 3 schematically show an example of three-dimensional angular selectivity of transmittance of directional light for a possible impinging light ray 30′ from source 26′. Impinging light ray 30′ is transmitted through tessellation layer 12A through a non-attenuating region 18 of module 14A and inter-layer gap 20, but is rejected by an attenuation region 16′ within an adjacent module 14B of tessellation layer 12B.

FIG. 2 and FIG. 3 schematically show an example of three-dimensional angular selectivity of transmittance of directional light for a possible impinging light ray 32 from source 26. Impinging light ray 32 is transmitted through tessellation layer 12A through a non-attenuating region 18 of module 14A and inter-layer gap 20 continuing through a non attenuation region 18 within module 14B of tessellation layer 12B to transmit into interior 24B.

In accordance with one embodiment a light moderator consisting of multiple layers 10 of parallel planar light attenuation devices 12 wherein each layer consists of a plane of an irregular collections of opaque attenuating regions 16 of particular geometries, and the multiple layers are sufficiently separated by the inter-layer gap 20 to leverage the relative geometries of attenuating 16 and non-attenuating 18 regions to selectively moderate the transmission of three-dimensional directional light 28-32 through the aggregation from the source 26 into the moderated interior 24B.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An article of manufacture, comprising:
an aggregated plurality of structured planes fixed in spatial adjacency, said planes are subdivided into modules, wherein said modules consist of an irregular collection of light-reduction geometries, and means for selectively filtering of three-dimensional angles of directional light transmission through said structured planes, whereby, an environment beyond said plurality of structured planes is moderated.

2. An article of manufacture, comprising:
an assembly of two or more non-coincident parallel locally separating two environments, said parallel planes each consist of a layer of patterned tessellations, and said tessellations contain non-uniform groups of non-linear attenuating and non-attenuating regions, and means for variable transmission of three-dimensional directional light through said assembly, whereby, said environment separated by said assembly from a source of light is moderated.
